(19) United States
(12) Patent Application Publication
(10) Pub. No.: US 2020/0307955 A1
(43) Pub. Date: Oct. 1, 2020

(54) REAL-TIME MONITORING SYSTEM, ELEVATOR OR ESCALATOR COMPRISING THE SAME, AND A METHOD THEREFOR

(71) Applicants: KONE Elevators Co., Ltd., Kunshan (CN); KONE CORPORATION, Helsinki (FI)

(72) Inventors: Tao YE, Kunshan (CN); Chengdong PU, Kunshan (CN); Weibin YU, Kunshan (CN)

(73) Assignees: KONE Elevators Co., Ltd., Kunshan (CN); KONE CORPORATION, Helsinki (FI)

(21) Appl. No.: 16/826,972

(22) Filed: Mar. 23, 2020

(30) Foreign Application Priority Data
Mar. 26, 2019 (CN) 201910231351.6

(51) Int. Cl. B66B 5/00; B66B 3/00; B66B 1/34; B66B 25/00; B66B 27/00; G06K 9/00; H04N 5/225

(52) U.S. Cl. CPC B66B 5/0025; B66B 3/002; B66B 1/3461; F16M 13/022; B66B 27/00; G06K 9/00771; H04N 5/2253; B66B 25/006

(57) ABSTRACT

The present invention discloses a real-time monitoring system for an elevator or an escalator, the elevator or escalator includes a control system arranged in a control cabinet, the control system includes a screen configured to display control information, the real-time monitoring system is arranged in the control cabinet, and includes: a camera configured to capture an image of the screen in real time; a visual information processing board configured to recognize the captured image as corresponding text data, and process the text data to form a message to be transmitted; and a data transfer unit configured to transmit the message from the visual information processing board to a cloud, wherein the cloud determines whether the elevator or the escalator needs maintenance according to the message.

### FIELD OF THE INVENTION

The invention relates to a real-time monitoring system for an elevator or an escalator, an elevator or an escalator comprising the same, and a method for real-time monitoring of the elevator or the escalator.

### BACKGROUND OF THE INVENTION

An elevator or escalator comprises a control system that performs control of the elevator or escalator. If the monitoring system needs to obtain information from the control system in real time, or the monitoring system needs accurate statistics of the elevator or escalator, RS232/485 or other devices are usually used to connect the monitoring system and the control system to retrieve information from the controller in real time. However, there are too many kinds of controllers on the market, and even controllers made by the same manufacturer may cause differences in communication protocols due to different software versions, which limits the applicability of many existing monitoring systems. Furthermore, if the communication is not designed properly, the interaction of the monitoring system with the control system may bring a risk of an unexpected stop of units. Therefore, a universal monitoring method is urgently needed without too much relying on the software and hardware of the control system.

### BRIEF DESCRIPTION OF THE INVENTION

In view of the above problems, the present invention provides a real-time monitoring system for an elevator or an escalator, the elevator or escalator comprises a control system arranged in a control cabinet, the control system comprises a screen configured to display control information, the real-time monitoring system is arranged in the control cabinet, and comprises: a camera configured to capture an image of the screen in real time; a visual information processing board configured to recognize the captured image as corresponding text data, and process the text data to form a message to be transmitted; and a data transfer unit configured to transmit the message from the visual information processing board to a cloud, wherein the cloud determines whether the elevator or the escalator needs maintenance according to the message.

This technical solution completely isolates communication over ports of any control system, thus avoiding all risks that cause unexpected problems to the units. And because the visual recognition only depends on the information display inside the control cabinet, the information display exists in most cases no matter which manufacturer. Therefore, this technical solution can cover almost all elevators and escalators, and is suitable for almost all types of controllers, as long as the information display exists. Further, because the monitoring system is physically isolated from the control system, it can be used with the device more securely without adding more computing effort.

According to the real-time monitoring system of the present invention, one or more of the following features may be provided individually or in combination.

According to an embodiment of the real-time monitoring system of the present invention, the visual information processing board includes a database associating a predetermined image having a specific feature with corresponding text data such that the visual information processing board recognizes the captured image as corresponding text data by comparison between the captured image and the predetermined image.

With this database, visual recognition becomes simpler. The recognition can be realized quickly by comparing specific features of the predetermined image and the captured image.

According to an embodiment of the real-time monitoring system of the present invention, the control information comprises running status information and/or fault event information.

Thus the monitoring system can monitor the running status and/or failure events of the elevator or escalator in real time.

According to an embodiment of the real-time monitoring system of the present invention, the processing of the text data by the visual information processing board comprises integrating successive identical text data for a predetermined time to avoid repeated message transmission.

By integrating successive identical text data, repeated message transmission can be avoided, thereby reducing the frequency of sending messages and saving subsequent calculations and processing efforts.

According to an embodiment of the real-time monitoring system of the present invention, the visual information processing board is further configured to store the image and the text data.

The storage of real-time images leads to the fact that real-time images can be provided as true evidences when examining fault events or reviewing occurrences. The storage of text data can be used for subsequent data processing and data statistics.

According to an embodiment of the real-time monitoring system of the present invention, the visual information processing board is further configured to calculate statistical data and make the statistical data as part of the message, the statistical data comprises fault duration, running up time, running down time, and/or stopping service time.

The statistical data obtained by statistical calculation of historical data can evaluate the status of the elevator or escalator, and serve as the basis for the maintenance of the elevator or escalator.

According to an embodiment of the real-time monitoring system of the present invention, the data transfer unit transmits a message to the cloud through 2G/3G/4G/5G.

Messages can be transmitted over long distances, enabling subsequent actions, including timely notification to management and maintenance personnel.

According to an embodiment of the real-time monitoring system of the present invention, the camera is positioned to directly align with the screen, or the real-time monitoring system further comprises a mirror configured to project an image of the screen to the camera such that the camera is indirectly aligned with the screen.

Depending on the space in the control cabinet, the camera can be directly or indirectly aligned with the screen. The use of the mirror can enable the camera to take photos in a control cabinet with a small space.

According to an embodiment of the real-time monitoring system of the present invention, the real-time monitoring system further comprises a bracket, the camera is mounted on the bracket such that the camera can move horizontally and/or vertically and/or rotate by the bracket in order to align with the screen.

The bracket is used to ensure that the camera is aligned with the screen, and the position of the camera can be adjusted after a period of use.

According to an embodiment of the real-time monitoring system of the present invention, the camera captures an image in a frequency range of every 0.1 second to every 1 second.

By properly setting the frequency to capture images, all events can be recorded while saving energy.

According to an embodiment of the real-time monitoring system of the present invention, when the cloud determines that the elevator or escalator needs maintenance, an alarm is issued and/or a maintenance person is assigned to the maintenance.

Logic can be constructed to implement actions in different situations based on urgency level to perform more efficient maintenance of the elevator or escalator.

The invention also provides an elevator or escalator, comprising the above-mentioned real-time monitoring system.

The invention also provides a method for real-time monitoring of an elevator or escalator, the elevator or escalator comprises a control system arranged in a control cabinet, the control system comprises a screen configured to display control information, the method comprising: capturing an image of the screen in real time by a camera disposed in the control cabinet; recognizing the captured image as corresponding text data by a visual information processing board disposed in the control cabinet, and processing the text data to form a message to be transmitted; and transmitting the message from the visual information processing board to a cloud by a data transfer unit disposed in the control cabinet, wherein the cloud determines whether the elevator or escalator needs maintenance according to the message.

This method completely isolates communication over ports of any control system, thus avoiding all risks that cause unexpected problems to the units. And because the visual recognition only depends on the information display inside the control cabinet, the information display exists in most cases no matter which manufacturer. Therefore, this technical solution can cover almost all elevators and escalators, and is suitable for almost all types of controllers, as long as the information display exists. Further, because the monitoring system is physically isolated from the control system, it can be used with the device more securely without adding more computing effort.

According to an embodiment of the method of the present invention, the visual information processing board includes a database associating a predetermined image having a specific feature with corresponding text data, the method further comprises: recognizing the captured image as corresponding text data through comparison between the captured image and the predetermined image by the visual information processing board.

With this database, visual recognition becomes simpler. The recognition can be realized quickly by comparing specific features of the predetermined image and the captured image.

According to an embodiment of the method of the present invention, the control information comprises running status information and/or fault event information.

Thus the monitoring system can monitor the running status and/or failure events of the elevator or escalator in real time.

According to an embodiment of the method of the present invention, the processing of the text data by the visual information processing board comprises integrating successive identical text data for a predetermined time to avoid repeated message transmission.

By integrating successive identical text data, repeated message transmission can be avoided, thereby reducing the frequency of sending messages and saving subsequent calculations and processing efforts.

According to an embodiment of the method of the present invention, the method further comprises storing the image and the text data by the visual information processing board.

The storage of real-time images leads to the fact that real-time images can be provided as true evidences when examining fault events or reviewing occurrences. The storage of text data can be used for subsequent data processing and data statistics.

According to an embodiment of the method of the present invention, the method further comprises calculating statistical data and making the statistical data as part of the message by the visual information processing board, the statistical data comprises fault duration, running up time, running down time, and/or stopping service time.

The statistical data obtained by statistical calculation of historical data can evaluate the status of the elevator or escalator, and serve as the basis for the maintenance of the elevator or escalator.

According to an embodiment of the method of the present invention, the data transfer unit transmits a message to the cloud through 2G/3G/4G/5G.

Messages can be transmitted over long distances, enabling subsequent actions, including timely notification to management and maintenance personnel.

According to an embodiment of the method of the present invention, the camera is positioned to directly align with the screen, or the real-time monitoring system further comprises a mirror configured to project an image of the screen to the camera such that the camera is indirectly aligned with the screen.

Depending on the space in the control cabinet, the camera can be directly or indirectly aligned with the screen. The use of the mirror can enable the camera to take photos in a control cabinet with a small space.

According to an embodiment of the method of the present invention, the camera is mounted on a bracket such that the camera can move horizontally and/or vertically and/or rotate by the bracket in order to align with the screen.

The bracket is used to ensure that the camera is aligned with the screen, and the position of the camera can be adjusted after a period of use.

According to an embodiment of the method of the present invention, the camera captures an image in a frequency range of every 0.1 second to every 1 second.

By properly setting the frequency to capture images, all events can be recorded while saving energy.

According to an embodiment of the method of the present invention, when the cloud determines that the elevator or escalator needs maintenance, an alarm is issued and/or a maintenance person is assigned to the maintenance.

Logic can be constructed to implement actions in different situations based on urgency level to perform more efficient maintenance of the elevator or escalator.

### BRIEF DESCRIPTION OF THE DRAWINGS

In order to explain the technical solution of the embodiment of the present invention more clearly, the drawings of the embodiment of the present invention will be briefly introduced below. Among them, the drawings are only used to show some embodiments of the present invention, rather than limiting all the embodiments of the present invention.

FIG. 1 is a schematic diagram of a real-time monitoring system according to the present invention.

FIG. 2 is a schematic diagram of a camera according to the present invention using a mirror to indirectly align with a screen.

### DETAILED DESCRIPTION

In order to make the objectives, technical solutions, and advantages of the technical solutions of the present invention clearer, the technical solutions of the embodiments of the present invention will be clearly and completely described below with reference to the accompanying drawings of specific embodiments of the present invention. The same reference numerals in the drawings represent the same components. It should be noted that the described embodiments are a part of the embodiments of the present invention, but not all the embodiments. Based on the described embodiments of the present invention, all other embodiments obtained by those skilled in the art without creative labor shall fall within the protection scope of the present invention.

Unless otherwise defined, the technical or scientific terms used herein shall have the ordinary meanings understood by those skilled in the art. The terms “first”, “second” and similar words used in the specification and claims of the present invention do not indicate any order, quantity, or importance, but are only used to distinguish different components. Similarly, similar words such as “a” or “an” do not necessarily indicate a limit on quantity. Words such as “including” or “comprising” mean that the element or item appearing before the word encompasses the element or item appearing after the word and its equivalent without excluding other elements or items. Words such as “connected” or “connecting” are not limited to physical or mechanical connections, but may include electrical connections, whether direct or indirect. “Up”, “down”, “left”, “right”, etc. are only used to indicate the relative position relationship. When the absolute position of the described object changes, the relative position relationship may also change accordingly.

The present invention is described in detail below by way of describing example embodiments.

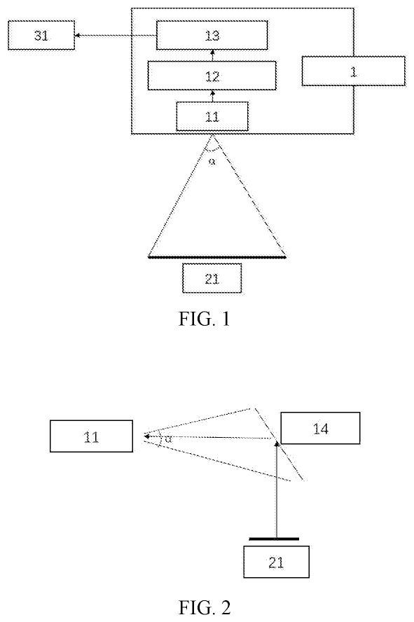

FIG. 1 is a schematic diagram of a real-time monitoring system 1 according to the present invention. The real-time monitoring system 1 is used for an elevator or an escalator. The elevator or escalator comprises a control system arranged in a control cabinet, the control system comprises a screen 21 configured to display control information. The real-time monitoring system 1 is arranged in the control cabinet, and comprises: a camera 11 configured to capture an image of the screen 21 in real time; a visual information processing board 12 configured to recognize the captured image as corresponding text data, and process the text data to form a message to be transmitted; and a data transfer unit 13 configured to transmit the message from the visual information processing board 12 to a cloud 31. Wherein the cloud 31 determines whether the elevator or the escalator needs maintenance according to the message.

This design of the real-time monitoring system 1 completely isolates communication over ports of any control system, thus avoiding all risks that cause unexpected problems to the units. And because the visual recognition only depends on the information display inside the control cabinet, the information display exists in most cases no matter which manufacturer. Therefore, this real-time monitoring system 1 can cover almost all elevators and escalators, and is suitable for almost all types of controllers, as long as the information display exists. Further, because the real-time monitoring system 1 is physically isolated from the control system, it can be used with the device more securely without adding more computing effort.

It can be understood that the camera 11, the visual information processing board 12, and the data transfer unit 13 of the real-time monitoring system 1 may communicate with each other in a wired or wireless manner. For example, the camera 11 is connected to the visual information processing board 12 in a wired manner. The visual information processing board 12 is connected to the data transfer unit 13 in a wireless manner (such as WiFi, Bluetooth, etc.).

When the cloud 31 determines that the elevator or escalator needs maintenance, an alarm may be issued and/or a maintenance person may be assigned to the maintenance. Logic may be constructed to implement actions in different situations based on urgency level to perform more efficient maintenance of the elevator or escalator. For example, faults can be classified into different levels. When a fault with high urgency level occurs, a maintenance person is assigned for immediate emergency rescue. When a fault with low urgency level occurs, a maintenance person may be ordered to make it done within a specified period of time.

Preferably, the visual information processing board 12 may include a database associating a predetermined image having a specific feature with corresponding text data such that the visual information processing board 12 recognizes the captured image as corresponding text data by comparison between the captured image and the predetermined image. With this database, visual recognition becomes simpler. The recognition can be realized quickly by comparing specific features of the predetermined image and the captured image. For example, when a fault occurs, the screen usually displays a fault code indicating the fault. The fault code is usually a number having a few digits, for example, a two digit number. Then, the database can associate an image displaying the two digit number with a text of this two digit number. In this way, when the fault code is displayed on the screen, for example, the image of 23 is displayed, the visual information processing board 12 can quickly recognize the image of the displayed 23 as text data of “23” through the association relationship of the database.

Preferably, the control information may comprise running status information and/or fault event information. Thus the monitoring system can monitor the running status and/or failure events of the elevator or escalator in real time. In fact, the real-time monitoring system 1 can monitor all the control information displayed on the screen by the control system in real time.

Preferably, the processing of the text data by the visual information processing board 12 may comprise integrating successive identical text data for a predetermined time to avoid repeated message transmission. By integrating successive identical text data, repeated message transmission can be avoided, thereby reducing the frequency of sending messages and saving subsequent calculations and processing efforts.

Preferably, the visual information processing board may be further configured to store the image and the text data. The storage of real-time images leads to the fact that real-time images can be provided as true evidences when examining fault events or reviewing occurrences. The storage of text data can be used for subsequent data processing and data statistics.

Preferably, the visual information processing board 12 may be further configured to calculate statistical data and make the statistical data as part of the message, the statistical data comprises fault duration, running up time, running down time, and/or stopping service time. The statistical data obtained by statistical calculation of historical data can evaluate the status of the elevator or escalator, and serve as the basis for the maintenance of the elevator or escalator. For example, the visual information processing board 12 may calculate the actual running time of an escalator in a shopping mall. The running time does not include the downtime of the escalator when the shopping mall is closed at night and the downtime of the escalator when it fails. A message requiring periodic maintenance is sent to the cloud 31 through the data transfer unit 13 when the calculated running time reaches a predetermined threshold.

Preferably, the data transfer unit may transmit a message to the cloud through 2G/3G/4G/5G. Messages can be transmitted over long distances by 2G/3G/4G/5G, enabling subsequent actions, including timely notification to management and maintenance personnel.

In general, the camera 11 may be positioned to directly align with the screen 21 as shown in FIG. 1. Wherein a is an angle of view of the camera 11. When the space in the control cabinet is large enough to be larger than the required technical distance between the camera 11 and the screen 21, that is, the camera 11 can be positioned such that the screen 21 is located in the field of view of camera 11, the camera 11 can be directly aligned with the screen 21.

FIG. 2 is a schematic diagram of a camera 11 according to the present invention using a mirror 14 to indirectly align with a screen 21. As shown in FIG. 2, when the space to directly align with the screen 21 is limited, and the camera 11 cannot be installed or a clear image cannot be obtained after installation, if there is a large size margin in the other dimension direction, a mirror 14 can be used to obtain images, and the camera 11 can be arranged in the direction with a large size margin to obtain images of the screen 21 in the mirror 14. That is, the real-time monitoring system 1 may further comprise a mirror 14 configured to project an image of the screen 31 to the camera 11 such that the camera 11 is indirectly aligned with the screen 21.

Preferably, the real-time monitoring system 1 may further comprise a bracket, the camera 11 is mounted on the bracket such that the camera can move horizontally and/or vertically and/or rotate by the bracket in order to align with the screen 21. The position of the camera 11 may be adjusted by the bracket to ensure that the camera 11 is aligned with the screen 21, and the position of the camera 11 can be adjusted after a period of use. Further, the bracket may be configured to adjust the position of the camera 11 automatically to ensure that the camera 11 is aligned with the screen 21.

Optionally, the camera 11 captures an image in a frequency range of every 0.1 second to every 1 second. By properly setting the frequency to capture images, all events can be recorded while saving energy.

The invention also provides an elevator or escalator, comprising the above-mentioned real-time monitoring system 1.

The invention also provides a method for real-time monitoring of an elevator or escalator, the elevator or escalator comprises a control system arranged in a control cabinet, the control system comprises a screen configured to display control information, the method comprising: capturing an image of the screen in real time by a camera disposed in the control cabinet; recognizing the captured image as corresponding text data by a visual information processing board disposed in the control cabinet, and processing the text data to form a message to be transmitted; and transmitting the message from the visual information processing board to a cloud by a data transfer unit disposed in the control cabinet, wherein the cloud determines whether the elevator or escalator needs maintenance according to the message.

This method completely isolates communication over ports of any control system, thus avoiding all risks that cause unexpected problems to the units. And because the visual recognition only depends on the information display inside the control cabinet, the information display exists in most cases no matter which manufacturer. Therefore, this technical solution can cover almost all elevators and escalators, and is suitable for almost all types of controllers, as long as the information display exists. Further, because the monitoring system is physically isolated from the control system, it can be used with the device more securely without adding more computing effort.

The method according to the present invention comprises one or more features similar to the above-mentioned real-time monitoring system, and details are not described herein again.

The exemplary embodiments of the real-time monitoring system, the elevator or escalator, and the method for real-time monitoring of an elevator or escalator provided by the present invention are described in detail above with reference to preferred embodiments. However, those skilled in the art can understand that without departing from the present invention, on the premise of the inventive concept, a variety of variations and modifications can be made to the above specific embodiments, and various technical features and structures proposed by the present invention can be combined in various ways without exceeding the scope of protection of the present invention.

### REFERENCE LIST

1 real-time monitoring system
11 camera
12 visual information processing board
13 data transfer unit
14 mirror
21 screen
31 cloud

1. A real-time monitoring system for an elevator or an escalator, the elevator or escalator comprises a control system arranged in a control cabinet, the control system comprises a screen configured to display control information, the real-time monitoring system is arranged in the control cabinet, and comprises:
a camera configured to capture an image of the screen in real time;
a visual information processing board configured to recognize the captured image as corresponding text data, and process the text data to form a message to be transmitted; and
a data transfer unit configured to transmit the message from the visual information processing board to a cloud,
wherein the cloud determines whether the elevator or the escalator needs maintenance according to the message.

2. The real-time monitoring system according to claim 1, wherein the visual information processing board includes a database associating a predetermined image having a specific feature with corresponding text data such that the visual information processing board recognizes the captured image as corresponding text data by comparison between the captured image and the predetermined image.

3. The real-time monitoring system according to claim 1, wherein the control information comprises running status information and/or fault event information.

4. The real-time monitoring system according to claim 1, wherein the processing of the text data by the visual information processing board comprises integrating successive identical text data for a predetermined time to avoid repeated message transmission.

5. The real-time monitoring system according to claim 1, wherein the visual information processing board is further configured to store the image and the text data.

6. The real-time monitoring system according to claim 1, wherein the visual information processing board is further configured to calculate statistical data and make the statistical data as part of the message, the statistical data comprises fault duration, running up time, running down time, and/or stopping service time.

7. The real-time monitoring system according to claim 1, wherein the camera is positioned to directly align with the screen, or the real-time monitoring system further comprises a mirror configured to project an image of the screen to the camera such that the camera is indirectly aligned with the screen.

8. The real-time monitoring system according to claim 1, wherein the real-time monitoring system further comprises a bracket, the camera is mounted on the bracket such that the camera can move horizontally and/or vertically and/or rotate by the bracket in order to align with the screen.

9. The real-time monitoring system according to claim 1, wherein the camera captures an image in a frequency range of every 0.1 second to every 1 second.

10. The real-time monitoring system according to claim 1, wherein when the cloud determines that the elevator or escalator needs maintenance, an alarm is issued and/or a maintenance person is assigned to the maintenance.

11. An elevator or escalator, characterized by comprising a real-time monitoring system according to claim 1.

12. A method for real-time monitoring of an elevator or escalator, the elevator or escalator comprises a control system arranged in a control cabinet, the control system comprises a screen configured to display control information, the method comprising:
capturing an image of the screen in real time by a camera disposed in the control cabinet;
recognizing the captured image as corresponding text data by a visual information processing board disposed in the control cabinet, and processing the text data to form a message to be transmitted; and
transmitting the message from the visual information processing board to a cloud by a data transfer unit disposed in the control cabinet,
wherein the cloud determines whether the elevator or escalator needs maintenance according to the message.

13. The method according to claim 12, wherein the visual information processing board includes a database associating a predetermined image having a specific feature with corresponding text data, the method further comprises:
recognizing the captured image as corresponding text data through comparison between the captured image and the predetermined image by the visual information processing board.

14. The method according to claim 12, wherein the control information comprises running status information and/or fault event information.

15. The method according to claim 12, wherein the processing of the text data by the visual information processing board comprises integrating successive identical text data for a predetermined time to avoid repeated message transmission.

16. The method according to claim 12, wherein the method further comprises storing the image and the text data by the visual information processing board.

17. The method according to claim 12, wherein the method further comprises calculating statistical data and making the statistical data as part of the message by the visual information processing board, the statistical data comprises fault duration, running up time, running down time, and/or stopping service time.

18. The method according to claim 12, wherein the camera is positioned to directly align with the screen, or the real-time monitoring system further comprises a mirror configured to project an image of the screen to the camera such that the camera is indirectly aligned with the screen.

19. The method according to claim 12, wherein the camera is mounted on a bracket such that the camera can move horizontally and/or vertically and/or rotate by the bracket in order to align with the screen.

20. The method according to claim 12, wherein the camera captures an image in a frequency range of every 0.1 second to every 1 second.
